(19) United States
(12) Patent Application Publication
(10) Pub. No.: US 2022/0071295 A1
(43) Pub. Date: Mar. 10, 2022

(54) VAPING MONITOR SYSTEM AND METHOD

(71) Applicant: Nicoventures Trading Limited, London (GB)

(72) Inventors: Oriol STROPHAIR, London (GB); David LEADLEY, London (GB); Maurice EZEOKE, London (GB)

(21) Appl. No.: 17/309,821

(22) PCT Filed: Dec. 10, 2019
(86) PCT No.: PCT/GB2019/053484

§ 371 Date: Jun. 21, 2021

(30) Foreign Application Priority Data
Dec. 21, 2018 (GB) 1821088.0

(51) Int. Cl. A24F 40/53; A24F 40/51; A24F 40/60; A24F 40/65

(52) U.S. Cl. CPC A24F 40/53; A24F 40/65; A24F 40/60; A24F 40/51

(57) ABSTRACT

A vaping monitor system comprises an electronic vapor provision system (EVPS) operable to generate vapor from a payload in response to an inhalation by a user, and to supply inhalation data to a dosage processor that is operable to calculate an amount of an active ingredient delivered to the user's bloodstream based on pharmacokinetic data for the EVPS and the inhalation data, the dosage processor also being operable to convert the calculated amount of an active ingredient into an equivalent number of a reference conventional combustion product based on pharmacokinetic data for the reference conventional combustion product, and the vaping monitor system being operable to indicate the equivalent number of a reference conventional combustion product via a user interface.

### PRIORITY CLAIM

The present application is a National Phase entry of PCT Application No. PCT/GB2019/053484, filed Dec. 10, 2019, which claims priority from GB Patent Application No. 1821088.0, filed Dec. 21, 2018, each of which is hereby fully incorporated herein by reference.

### FIELD

The present invention relates to a vaping monitor system and method.

### BACKGROUND

Electronic vapor provision systems (EVPSs), such as e-cigarettes and other aerosol delivery systems, are complex devices comprising a power source sufficient to ca volatile material, together with control circuitry, a heating element and typically a liquid, gel or solid payload from which to obtain the vapor/aerosol. Some EVPSs also comprise communication systems and/or computing capabilities.

In use, the device is intended to deliver a vapor comprising the volatile material to the user for inhalation, typically by heating a portion of the payload to a sufficient temperature to vaporize the volatile material.

The device is typically used as a companion or substitute for more traditional combustion based smoking, with a similar effect of delivering an active ingredient such as nicotine to the user's bloodstream.

However, the user may not have a clear sense of how much active ingredient they are receiving during normal use.

### SUMMARY

The present invention seeks to alleviate or mitigate this problem.

In a first aspect, a vaping monitor system is provided in accordance with claim 1.

In another aspect, a mobile communication device is provided in accordance with claim 11.

In another aspect, vapor monitoring method is provided in accordance with claim 15.

In another aspect, a vaping monitoring method for a mobile communication device is provided in accordance with claim 22.

Further respective aspects and features of the invention are defined in the appended claims.

### BRIEF DESCRIPTION OF THE DRAWINGS

Embodiments of the present invention will now be described by way of example with reference to the accompanying drawings, in which:

FIG. 1 is a schematic diagram of an e-cigarette in accordance with embodiments of the present invention.

FIG. 2 is a schematic diagram of a control unit of an e-cigarette in accordance with embodiments of the present invention.

FIG. 3 is a schematic diagram of a processor of an e-cigarette in accordance with embodiments of the present invention.

FIG. 4 is a schematic diagram of an e-cigarette in communication with a mobile terminal in accordance with embodiments of the present invention.

FIG. 5 is a schematic diagram of a cartomizer of an e-cigarette.

FIG. 6 is a schematic diagram of a vaporizer or heater of an e-cigarette.

FIG. 7 is a schematic diagram of a mobile terminal in accordance with embodiments of the present invention.

FIG. 8 is a flow diagram of a vapor monitoring method in accordance with embodiments of the present invention.

FIG. 9 is a flow diagram of a vapor monitoring method for a mobile communication device in accordance with embodiments of the present invention.

FIG. 10 is a flow diagram of a vapor monitoring method for a server in accordance with embodiments of the present invention.

### DETAILED DESCRIPTION

A vaping monitor system and method are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

By way of background explanation, electronic vapor provision systems, such as e-cigarettes and other aerosol delivery systems, generally contain a reservoir of liquid which is to be vaporized, typically nicotine (this is sometimes referred to as an “e-liquid”). When a user inhales on the device, an electrical (e.g. resistive) heater is activated to vaporize a small amount of liquid, in effect producing an aerosol which is therefore inhaled by the user. The liquid may comprise nicotine in a solvent, such as ethanol or water, together with glycerine or propylene glycol to aid aerosol formation, and may also include one or more additional flavors. The skilled person will be aware of many different liquid formulations that may be used in e-cigarettes and other such devices.

The practice of inhaling vaporized liquid in this manner is commonly known as ‘vaping’.

An e-cigarette may have an interface to support external data communications. This interface may be used, for example, to load control parameters and/or updated software onto the e-cigarette from an external source. Alternatively or additionally, the interface may be utilized to download data from the e-cigarette to an external system. The downloaded data may, for example, represent usage parameters of the e-cigarette, fault conditions, etc. As the skilled person will be aware, many other forms of data can be exchanged between an e-cigarette and one or more external systems (which may be another e-cigarette).

In some cases, the interface for an e-cigarette to perform communication with an external system is based on a wired connection, such as a USB link using a micro, mini, or ordinary USB connection into the e-cigarette. The interface for an e-cigarette to perform communication with an external system may also be based on a wireless connection. Such a wireless connection has certain advantages over a wired connection. For example, a user does not need any additional cabling to form such a connection. In addition, the user has more flexibility in terms of movement, setting up a connection, and the range of pairing devices.

Throughout the present description the term “e-cigarette” is used; however, this term may be used interchangeably with electronic vapor provision system, aerosol delivery device, and other similar terminology.

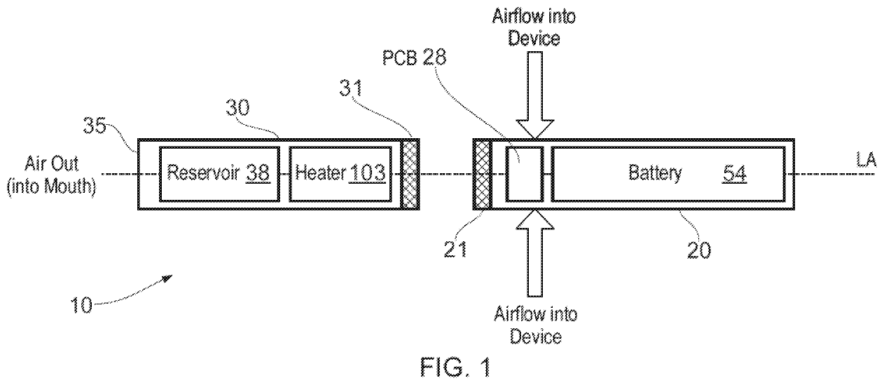

FIG. 1 is a schematic (exploded) diagram of an e-cigarette 10 in accordance with some embodiments of the disclosure (not to scale). The e-cigarette comprises a body or control unit 20 and a cartomizer 30. The cartomizer 30 includes a reservoir 38 of liquid, typically including nicotine, a heater 36, and a mouthpiece 35. The e-cigarette 10 has a longitudinal or cylindrical axis which extends along the center-line of the e-cigarette from the mouthpiece 35 at one end of the cartomizer 30 to the opposing end of the control unit 20 (usually referred to as the tip end). This longitudinal axis is indicated in FIG. 1 by the dashed line denoted LA.

The liquid reservoir 38 in the cartomizer may hold the (e-)liquid directly in liquid form, or may utilize some absorbing structure, such as a foam matrix or cotton material, etc, as a retainer for the liquid. The liquid is then fed from the reservoir 38 to be delivered to a vaporizer comprising the heater 36. For example, liquid may flow via capillary action from the reservoir 38 to the heater 36 via a wick (not shown in FIG. 1).

In other devices, the liquid may be provided in the form of plant material or some other (ostensibly solid) plant derivative material. In this case the liquid can be considered as representing volatiles in the material which vaporize when the material is heated. Note that devices containing this type of material generally do not require a wick to transport the liquid to the heater, but rather provide a suitable arrangement of the heater in relation to the material to provide suitable heating.

It will be appreciated that the heater is one example of a means to generate an aerosol/vapor. More generally, an aerosol generator is an apparatus configured to cause aerosol to be generated from an aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

It will also be appreciated that forms of payload delivery other than a liquid may be equally considered, such as heating a solid material (such as processed tobacco leaf) or a gel. In such cases, the volatiles that vaporize provide the active ingredient of the vapor/aerosol to be inhaled. It will be understood that references herein to ‘liquid’, ‘e-liquid’ and the like equally encompass other modes of payload delivery, and similarly references to ‘reservoir’ or similar equally encompass other means of storage, such as a container for solid materials.

Hence in general the aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

An aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The liquid, gel, botanical or other suitable source of vapor upon heating may deliver an active ingredient or active substance (the terms are considered interchangeable) within that vapor. The active substance as used herein may be a physiologically active material, which is a material intended to achieve or enhance a physiological response. The active substance may for example be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active ingredient or substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v.,Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active ingredient comprises or is derived from one or more botanicals or constituents, derivatives or extracts thereof and the botanical is tobacco.

In some embodiments, the active ingredient comprises or derived from one or more botanicals or constituents, derivatives or extracts thereof and the botanical is selected from eucalyptus, star anise, cocoa and hemp.

In some embodiments, the active ingredient comprises or derived from one or more botanicals or constituents, derivatives or extracts thereof and the botanical is selected from rooibos and fennel.

The control unit 20 includes a re-chargeable cell or battery 54 to provide power to the e-cigarette 10 (referred to hereinafter as a battery) and a printed circuit board (PCB) 28 and/or other electronics for generally controlling the e-cigarette.

The control unit 20 and the cartomizer 30 are detachable from one another, as shown in FIG. 1, but are joined together when the device 10 is in use, for example, by a screw or bayonet fitting. The connectors on the cartomizer 30 and the control unit 20 are indicated schematically in FIG. 1 as 31B and 21A respectively. This connection between the control unit and cartomizer provides for mechanical and electrical connectivity between the two.

When the control unit is detached from the cartomizer, the electrical connection 21A on the control unit that is used to connect to the cartomizer may also serve as a socket for connecting a charging device (not shown). The other end of this charging device can be plugged into a USB socket to re-charge the battery 54 in the control unit of the e-cigarette. In other implementations, the e-cigarette may be provided (for example) with a cable for direct connection between the electrical connection 21A and a USB socket.

The control unit is provided with one or more holes for air inlet adjacent to PCB 28. These holes connect to an air passage through the control unit to an air passage provided through the connector 21A. This then links to an air path through the cartomizer 30 to the mouthpiece 35. Note that the heater 36 and the liquid reservoir 38 are configured to provide an air channel between the connector 31B and the mouthpiece 35. This air channel may flow through the center of the cartomizer 30, with the liquid reservoir 38 confined to an annular region around this central path. Alternatively (or additionally) the airflow channel may lie between the liquid reservoir 38 and an outer housing of the cartomizer 30.

When a user inhales through the mouthpiece 35, air is drawn into the control unit 20 through the one or more air inlet holes. This airflow (or the associated change in pressure) is detected by a sensor, e.g. a pressure sensor, which in turn activates the heater 36 to vaporize the nicotine liquid fed from the reservoir 38. The airflow passes from the control unit into the vaporizer, where the airflow combines with the nicotine vapor. This combination of airflow and nicotine vapor (in effect, an aerosol) then passes through the cartomizer 30 and out of the mouthpiece 35 to be inhaled by a user. The cartomizer 30 may be detached from the control unit and disposed of when the supply of nicotine liquid is exhausted (and then replaced with another cartomizer). As noted previously herein, nicotine is a non-limiting example of an active ingredient.

It will be appreciated that the e-cigarette 10 shown in FIG. 1 is presented by way of example only, and many other implementations may be adopted. For example, in some implementations, the cartomizer 30 is split into a cartridge containing the liquid reservoir 38 and a separate vaporizer portion containing the heater 36. In this configuration, the cartridge may be disposed of after the liquid in reservoir 38 has been exhausted, but the separate vaporizer portion containing the heater 36 is retained. Alternatively, an e-cigarette may be provided with a cartomizer 30 as shown in FIG. 1, or else constructed as a one-piece (unitary) device, but the liquid reservoir 38 is in the form of a (user-)replaceable cartridge. Further possible variations are that the heater 36 may be located at the opposite end of the cartomizer 30 from that shown in FIG. 1, i.e. between the liquid reservoir 38 and the mouthpiece 35, or else the heater 36 is located along a central axis LA of the cartomizer, and the liquid reservoir is in the form of an annular structure which is radially outside the heater 35.

The skilled person will also be aware of a number of possible variations for the control unit 20. For example, airflow may enter the control unit at the tip end, i.e. the opposite end to connector 21A, in addition to or instead of the airflow adjacent to PCB 28. In this case the airflow would typically be drawn towards the cartomizer along a passage between the battery 54 and the outer wall of the control unit. Similarly, the control unit may comprise a PCB located on or near the tip end, e.g. between the battery and the tip end. Such a PCB may be provided in addition to or instead of PCB 28.

Furthermore, an e-cigarette may support charging at the tip end, or via a socket elsewhere on the device, in addition to or in place of charging at the connection point between the cartomizer and the control unit. (It will be appreciated that some e-cigarettes are provided as essentially integrated units, in which case a user is unable to disconnect the cartomizer from the control unit). Other e-cigarettes may also support wireless (induction) charging, in addition to (or instead of) wired charging.

The above discussion of potential variations to the e-cigarette shown in FIG. 1 is by way of example. The skilled person will aware of further potential variations (and combination of variations) for the e-cigarette 10.

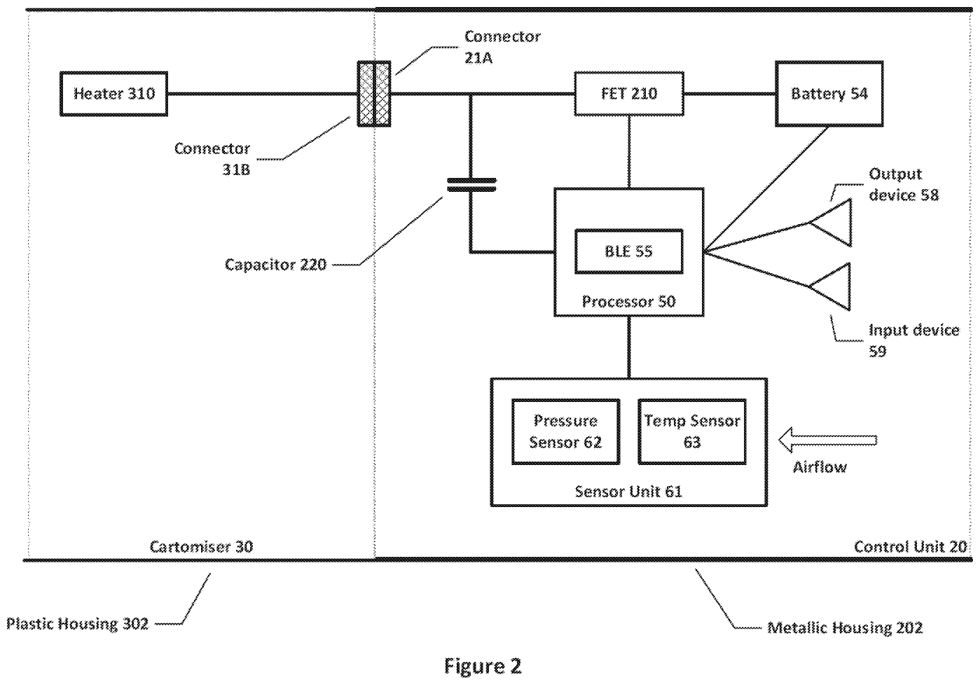

FIG. 2 is a schematic diagram of the main functional components of the e-cigarette 10 of FIG. 1 in accordance with some embodiments of the disclosure. N.B. FIG. 2 is primarily concerned with electrical connectivity and functionality—it is not intended to indicate the physical sizing of the different components, nor details of their physical placement within the control unit 20 or cartomizer 30. In addition, it will be appreciated that at least some of the components shown in FIG. 2 located within the control unit 20 may be mounted on the circuit board 28. Alternatively, one or more of such components may instead be accommodated in the control unit to operate in conjunction with the circuit board 28, but not physically mounted on the circuit board itself. For example, these components may be located on one or more additional circuit boards, or they may be separately located (such as battery 54).

As shown in FIG. 2, the cartomizer contains heater 310 which receives power through connector 31B. The control unit 20 includes an electrical socket or connector 21A for connecting to the corresponding connector 31B of the cartomizer 30 (or potentially to a USB charging device). This then provides electrical connectivity between the control unit 20 and the cartomizer 30.

The control unit 20 further includes a sensor unit 61, which is located in or adjacent to the air path through the control unit 20 from the air inlet(s) to the air outlet (to the cartomizer 30 through the connector 21A). The sensor unit contains a pressure sensor 62 and temperature sensor 63 (also in or adjacent to this air path). The control unit further includes a capacitor 220, a processor 50, a field effect transistor (FET) switch 210, a battery 54, and input and output devices 59, 58.

The operations of the processor 50 and other electronic components, such as the pressure sensor 62, are generally controlled at least in part by software programs running on the processor (or other components). Such software programs may be stored in non-volatile memory, such as ROM, which can be integrated into the processor 50 itself, or provided as a separate component. The processor 50 may access the ROM to load and execute individual software programs as and when required. The processor 50 also contains appropriate communications facilities, e.g. pins or pads (plus corresponding control software), for communicating as appropriate with other devices in the control unit 20, such as the pressure sensor 62.

The output device(s) 58 may provide visible, audio and/or haptic output. For example, the output device(s) may include a speaker 58, a vibrator, and/or one or more lights. The lights are typically provided in the form of one or more light emitting diodes (LEDs), which may be the same or different colors (or multi-colored). In the case of multi-colored LEDs, different colors are obtained by switching different colored, e.g. red, green or blue, LEDs on, optionally at different relative brightnesses to give corresponding relative variations in color. Where red, green and blue LEDs are provided together, a full range of colors is possible, whilst if only two out of the three red, green and blue LEDs are provided, only a respective sub-range of colors can be obtained.

The output from the output device may be used to signal to the user various conditions or states within the e-cigarette, such as a low battery warning. Different output signals may be used for signaling different states or conditions. For example, if the output device 58 is an audio speaker, different states or conditions may be represented by tones or beeps of different pitch and/or duration, and/or by providing multiple such beeps or tones. Alternatively, if the output device 58 includes one or more lights, different states or conditions may be represented by using different colors, pulses of light or continuous illumination, different pulse durations, and so on. For example, one indicator light might be utilized to show a low battery warning, while another indicator light might be used to indicate that the liquid reservoir 38 is nearly depleted. It will be appreciated that a given e-cigarette may include output devices to support multiple different output modes (audio, visual) etc.

The input device(s) 59 may be provided in various forms. For example, an input device (or devices) may be implemented as buttons on the outside of the e-cigarette—e.g. as mechanical, electrical or capacitive (touch) sensors. Some devices may support blowing into the e-cigarette as an input mechanism (such blowing may be detected by pressure sensor 62, which would then be also acting as a form of input device 59), and/or connecting/disconnecting the cartomizer 30 and control unit 20 as another form of input mechanism. Again, it will be appreciated that a given e-cigarette may include input devices 59 to support multiple different input modes.

As noted above, the e-cigarette 10 provides an air path from the air inlet through the e-cigarette, past the pressure sensor 62 and the heater 310 in the cartomizer 30 to the mouthpiece 35. Thus when a user inhales on the mouthpiece of the e-cigarette, the processor 50 detects such inhalation based on information from the pressure sensor 62. In response to such a detection, the CPU supplies power from the battery 54 to the heater, which thereby heats and vaporizes the nicotine from the liquid reservoir 38 for inhalation by the user.

In the particular implementation shown in FIG. 2, a FET 210 is connected between the battery 54 and the connector 21A. This FET 210 acts as a switch. The processor 50 is connected to the gate of the FET to operate the switch, thereby allowing the processor to switch on and off the flow of power from the battery 54 to heater 310 according to the status of the detected airflow. It will be appreciated that the heater current can be relatively large, for example, in the range 1-5 amps, and hence the FET 210 should be implemented to support such current control (likewise for any other form of switch that might be used in place of FET 210).

In order to provide more fine-grained control of the amount of power flowing from the battery 54 to the heater 310, a pulse-width modulation (PWM) scheme may be adopted. A PWM scheme may be based on a repetition period of say 1 ms. Within each such period, the switch 210 is turned on for a proportion of the period, and turned off for the remaining proportion of the period. This is parameterized by a duty cycle, whereby a duty cycle of 0 indicates that the switch is off for all of each period (i.e. in effect, permanently off), a duty cycle of 0.33 indicates that the switch is on for a third of each period, a duty cycle of 0.66 indicates that the switch is on for two-thirds of each period, and a duty cycle of 1 indicates that the FET is on for all of each period (i.e. in effect, permanently on). It will be appreciated that these are only given as example settings for the duty cycle, and intermediate values can be used as appropriate.

The use of PWM provides an effective power to the heater which is given by the nominal available power (based on the battery output voltage and the heater resistance) multiplied by the duty cycle. The processor 50 may, for example, utilize a duty cycle of 1 (i.e. full power) at the start of an inhalation to initially raise the heater 310 to its desired operating temperature as quickly as possible. Once this desired operating temperature has been achieved, the processor 50 may then reduce the duty cycle to some suitable value in order to supply the heater 310 with the desired operating power

As shown in FIG. 2, the processor 50 includes a communications interface 55 for wireless communications, in particular, support for Bluetooth® Low Energy (BLE) communications.

Optionally the heater 310 may be utilized as an antenna for use by the communications interface 55 for transmitting and receiving the wireless communications. One motivation for this is that the control unit 20 may have a metal housing 202, whereas the cartomizer portion 30 may have a plastic housing 302 (reflecting the fact that the cartomizer 30 is disposable, whereas the control unit 20 is retained and therefore may benefit from being more durable). The metal housing acts as a screen or barrier which can affect the operation of an antenna located within the control unit 20 itself. However, utilizing the heater 310 as the antenna for the wireless communications can help to avoid this metal screening because of the plastic housing of the cartomizer, but without adding additional components or complexity (or cost) to the cartomizer. Alternatively a separate antenna may be provided (not shown), or a portion of the metal housing may be used.

If the heater is used as an antenna then as shown in FIG. 2, the processor 50, more particularly the communications interface 55, may be coupled to the power line from the battery 54 to the heater 310 (via connector 31B) by a capacitor 220. This capacitive coupling occurs downstream of the switch 210, since the wireless communications may operate when the heater is not powered for heating (as discussed in more detail below). It will be appreciated that capacitor 220 helps prevent the power supply from the battery 54 to the heater 310 being diverted back to the processor 50.

Note that the capacitive coupling may be implemented using a more complex LC (inductor-capacitor) network, which can also provide impedance matching with the output of the communications interface 55. (As known to the person skilled in the art, this impedance matching can help support proper transfer of signals between the communications interface 55 and the heater 310 acting as the antenna, rather than having such signals reflected back along the connection).

In some implementations, the processor 50 and communications interface are implemented using a Dialog DA14580 chip from Dialog Semiconductor PLC, based in Reading, United Kingdom. Further information (and a data sheet) for this chip is available at: http://www.dialog-semiconductor.com/products/bluetooth-smart/smartbond-da14580.

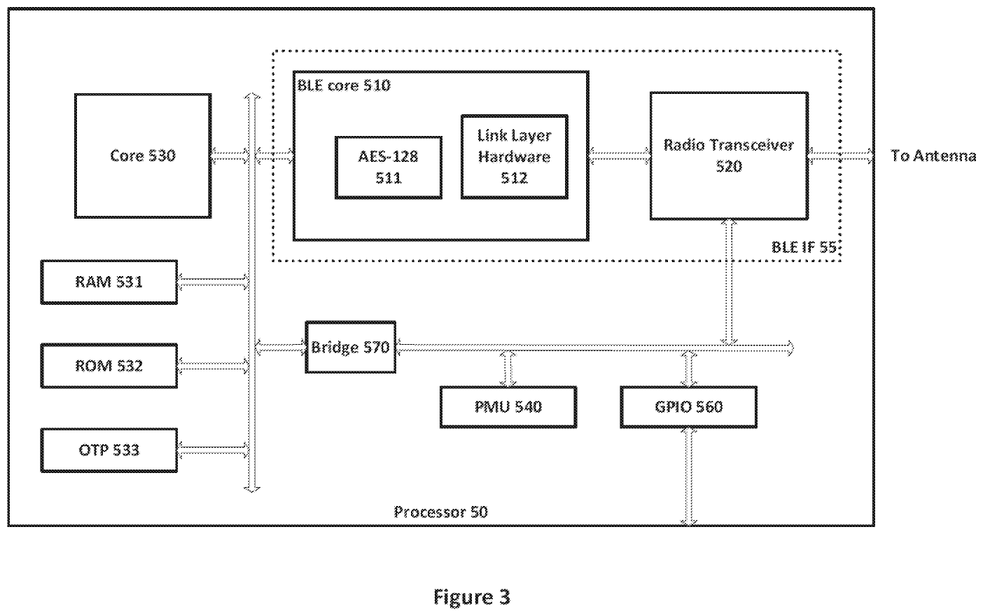

FIG. 3 presents a high-level and simplified overview of this chip 50, including the communications interface 55 for supporting Bluetooth® Low Energy. This interface includes in particular a radio transceiver 520 for performing signal modulation and demodulation, etc, link layer hardware 512, and an advanced encryption facility (128 bits) 511. The output from the radio transceiver 520 is connected to the antenna (for example, to the heater 310 acting as the antenna via capacitive coupling 220 and connectors 21A and 31B).

The remainder of processor 50 includes a general processing core 530, RAM 531, ROM 532, a one-time programming (OTP) unit 533, a general purpose I/O system 560 (for communicating with other components on the PCB 28), a power management unit 540 and a bridge 570 for connecting two buses. Software instructions stored in the ROM 532 and/or OTP unit 533 may be loaded into RAM 531 (and/or into memory provided as part of core 530) for execution by one or more processing units within core 530. These software instructions cause the processor 50 to implement various functionality described herein, such as interfacing with the sensor unit 61 and controlling the heater accordingly. Note that although the device shown in FIG. 3 acts as both a communications interface 55 and also as a general controller for the electronic vapor provision system 10, in other embodiments these two functions may be split between two or more different devices (chips)—e.g. one chip may serve as the communications interface 55, and another chip as the general controller for the electronic vapor provision system 10.

In some implementations, the processor 50 may be configured to prevent wireless communications when the heater is being used for vaporizing liquid from reservoir 38. For example, wireless communications may be suspended, terminated or prevented from starting when switch 210 is switched on. Conversely, if wireless communications are ongoing, then activation of the heater may be prevented—e.g. by disregarding a detection of airflow from the sensor unit 61, and/or by not operating switch 210 to turn on power to the heater 310 while the wireless communications are progressing.

One reason for preventing the simultaneous operation of heater 310 for both heating and wireless communications in some implementations is to help avoid potential interference from the PWM control of the heater. This PWM control has its own frequency (based on the repetition frequency of the pulses), albeit typically much lower than the frequency used for the wireless communications, and the two could potentially interfere with one another. In some situations, such interference may not, in practice, cause any problems, and simultaneous operation of heater 310 for both heating and wireless communications may be allowed (if so desired). This may be facilitated, for example, by techniques such as the appropriate selection of signal strengths and/or PWM frequency, the provision of suitable filtering, etc.

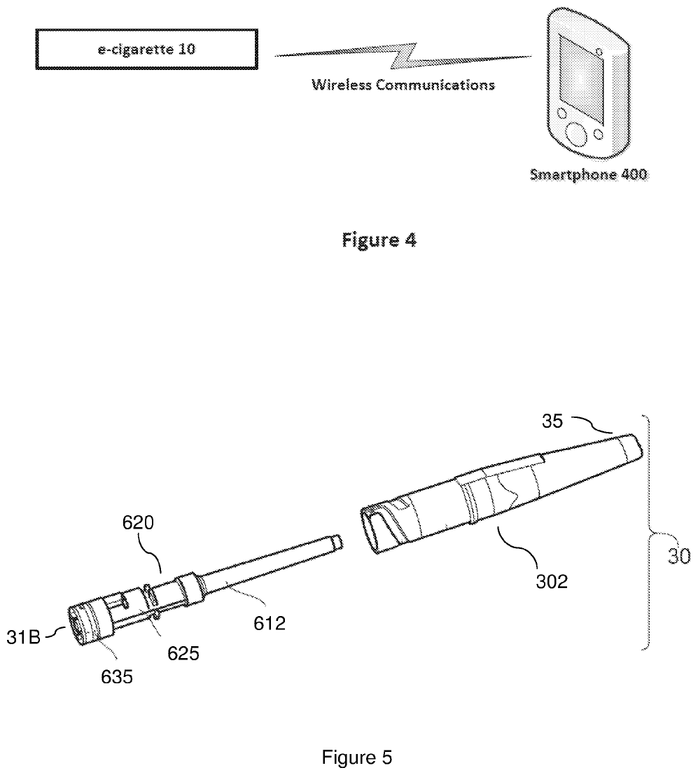

FIG. 4 is a schematic diagram showing Bluetooth® Low Energy communications between an e-cigarette 10 and an application (app) running on a smartphone 400 or other suitable mobile communication device (tablet, laptop, smartwatch, etc). Such communications can be used for a wide range of purposes, for example, to upgrade firmware on the e-cigarette 10, to retrieve usage and/or diagnostic data from the e-cigarette 10, to reset or unlock the e-cigarette 10, to control settings on the e-cigarette, etc.

In general terms, when the e-cigarette 10 is switched on, such as by using input device 59, or possibly by joining the cartomizer 30 to the control unit 20, it starts to advertise for Bluetooth® Low Energy communication. If this outgoing communication is received by smartphone 400, then the smartphone 400 requests a connection to the e-cigarette 10. The e-cigarette may notify this request to a user via output device 58, and wait for the user to accept or reject the request via input device 59. Assuming the request is accepted, the e-cigarette 10 is able to communicate further with the smartphone 400. Note that the e-cigarette may remember the identity of smartphone 400 and be able to accept future connection requests automatically from that smartphone. Once the connection has been established, the smartphone 400 and the e-cigarette 10 operate in a client-server mode, with the smartphone operating as a client that initiates and sends requests to the e-cigarette which therefore operates as a server (and responds to the requests as appropriate).

A Bluetooth® Low Energy link (also known as Bluetooth Smart®) implements the IEEE 802.15.1 standard, and operates at a frequency of 2.4-2.5 GHz, corresponding to a wavelength of about 12 cm, with data rates of up to 1 Mbit/s. The set-up time for a connection is less than 6 ms, and the average power consumption can be very low—of the order 1 mW or less. A Bluetooth Low Energy link may extend up to some 50 m. However, for the situation shown in FIG. 4, the e-cigarette 10 and the smartphone 400 will typically belong to the same person, and will therefore be in much closer proximity to one another—e.g. 1 m. Further information about Bluetooth Low Energy can be found at: http://www.bluetooth.com/Pages/Bluetooth-Smart.aspx

It will be appreciated that e-cigarette 10 may support other communications protocols for communication with smartphone 400 (or any other appropriate device). Such other communications protocols may be instead of, or in addition to, Bluetooth Low Energy. Examples of such other communications protocols include Bluetooth® (not the low energy variant), see for example, www.bluetooth.com, near field communications (NFC), as per ISO 13157, and WiFi®. NFC communications operate at much lower wavelengths than Bluetooth (13.56 MHz) and generally have a much shorter range—say <0.2 m. However, this short range is still compatible with most usage scenarios such as shown in FIG. 4. Meanwhile, low-power WiFi® communications, such as IEEE802.11ah, IEEE802.11v, or similar, may be employed between the e-cigarette 10 and a remote device. In each case, a suitable communications chipset may be included on PCB 28, either as part of the processor 50 or as a separate component. The skilled person will be aware of other wireless communication protocols that may be employed in e-cigarette 10.

FIG. 5 is a schematic, exploded view of an example cartomizer 30 in accordance with some embodiments. The cartomizer has an outer plastic housing 302, a mouthpiece 35 (which may be formed as part of the housing), a vaporizer 620, a hollow inner tube 612, and a connector 31B for attaching to a control unit. An airflow path through the cartomizer 30 starts with an air inlet through connector 31B, then through the interior of vaporizer 625 and hollow tube 612, and finally out through the mouthpiece 35. The cartomizer 30 retains liquid in an annular region between (i) the plastic housing 302, and (ii) the vaporizer 620 and the inner tube 612. The connector 31B is provided with a seal 635 to help maintain liquid in this region and to prevent leakage.

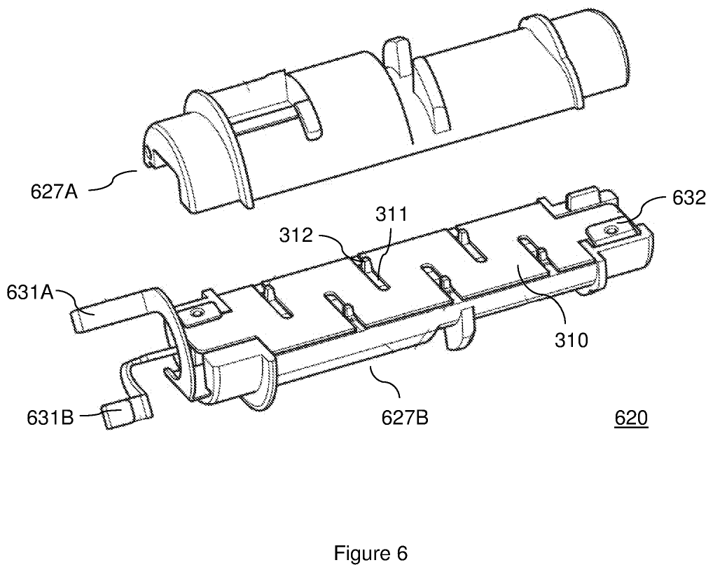

FIG. 6 is a schematic, exploded view of the vaporizer 620 from the example cartomizer 30 shown in FIG. 5. The vaporizer 620 has a substantially cylindrical housing (cradle) formed from two components, 627A, 627B, each having a substantially semi-circular cross-section. When assembled, the edges of the components 627A, 627B do not completely abut one another (at least, not along their entire length), but rather a slight gap 625 remains (as indicated in FIG. 5). This gap allows liquid from the outer reservoir around the vaporizer and tube 612 to enter into the interior of the vaporizer 620.

One of the components 627B of the vaporizer is shown in FIG. 6 supporting a heater 310. There are two connectors 631A, 631B shown for supplying power (and a wireless communication signal) to the heater 310. More particular, these connectors 631A, 631B link the heater to connector 31B, and from there to the control unit 20. (Note that connector 631A is joined to pad 632A at the far end of vaporizer 620 from connector 31B by an electrical connection that passes under the heater 310 and which is not visible in FIG. 6).

The heater 310 comprises a heating element formed from a sintered metal fiber material and is generally in the form of a sheet or porous, conducting material (such as steel). However, it will be appreciated that other porous conducting materials may be used. The overall resistance of the heating element in the example of FIG. 6 is around 1 ohm. However, it will be appreciated that other resistances may be selected, for example having regard to the available battery voltage and the desired temperature/power dissipation characteristics of the heating element. In this regard, the relevant characteristics may be selected in accordance with the desired aerosol (vapor) generation properties for the device depending on the source liquid of interest.

The main portion of the heating element is generally rectangular with a length (i.e. in a direction running between the connector 31B and the contact 632A) of around 20 mm and a width of around 8 mm. The thickness of the sheet comprising the heating element in this example is around 0.15 mm.

As can be seen in FIG. 6, the generally-rectangular main portion of the heating element has slots 311 extending inwardly from each of the longer sides. These slots 311 engage pegs 312 provided by vaporizer housing component 627B, thereby helping to maintain the position of the heating element in relation to the housing components 627A, 627B.

The slots extend inwardly by around 4.8 mm and have a width of around 0.6 mm. The slots 311 extending inwardly are separated from one another by around 5.4 mm on each side of the heating element, with the slots extending inwardly from the opposing sides being offset from one another by around half this spacing. A consequence of this arrangement of slots is that current flow along the heating element is in effect forced to follow a meandering path, which results in a concentration of current and electrical power around the ends of the slots. The different current/power densities at different locations on the heating element mean there are areas of relatively high current density that become hotter than areas of relatively low current density. This in effect provides the heating element with a range of different temperatures and temperature gradients, which can be desirable in the context of aerosol provision systems. This is because different components of a source liquid may aerosolize/vaporize at different temperatures, and so providing a heating element with a range of temperatures can help simultaneously aerosolize a range of different components in the source liquid.

The heater 310 shown in FIG. 6, having a substantially planar shape which is elongated in one direction, is well-suited to act as an antenna. In conjunction with the metal housing 202 of the control unit, the heater 310 forms an approximate dipole configuration, which typically has a physical size of the same order of magnitude as the wavelength of Bluetooth Low Energy communications—i.e. a size of several centimeters (allowing for both the heater 310 and the metal housing 202) against a wavelength of around 12 cm.

Although FIG. 6 illustrates one shape and configuration of the heater 310 (heating element), the skilled person will be aware of various other possibilities. For example, the heater may be provided as a coil or some other configuration of resistive wire. Another possibility is that the heater is configured as a pipe containing liquid to be vaporized (such as some form of tobacco product). In this case, the pipe may be used primarily to transport heat from a place of generation (e.g. by a coil or other heating element) to the liquid to be vaporized. In such a case, the pipe still acts as a heater in respect of the liquid to be heated. Such configurations can again optionally be used as an antenna to support wireless configurations.

As was noted previously herein, a suitable e-cigarette 10 can communicate with a mobile communication device 400, for example by paring the devices using the Bluetooth® low energy protocol.

Consequently, it is possible to provide additional functionality to the e-cigarette and/or to a system comprising the e-cigarette and the smart phone, by providing suitable software instructions (for example in the form of an app) to run on the smart phone.

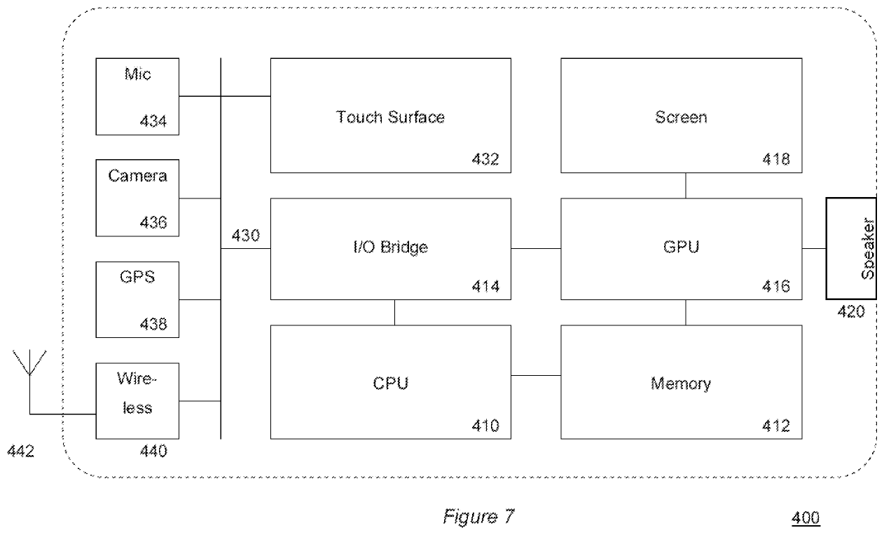

Turning now to FIG. 7, a typical smartphone 400 comprises a central processing unit (CPU) (410). The CPU may communicate with components of the smart phone either through direct connections or via an I/O bridge 414 and/or a bus 430 as applicable.

In the example shown in FIG. 7, the CPU communicates directly with a memory 412, which may comprise a persistent memory such as for example Flash® memory for storing an operating system and applications (apps), and volatile memory such as RAM for holding data currently in use by the CPU. Typically persistent and volatile memories are formed by physically distinct units (not shown). In addition, the memory may separately comprise plug-in memory such as a microSD card, and also subscriber information data on a subscriber information module (SIM) (not shown).

The smart phone may also comprise a graphics processing unit (GPU) 416. The GPU may communicate directly with the CPU or via the I/O bridge, or may be part of the CPU. The GPU may share RAM with the CPU or may have its own dedicated RAM (not shown) and is connected to the display 418 of the mobile phone. The display is typically a liquid crystal (LCD) or organic light-emitting diode (OLED) display, but may be any suitable display technology, such as e-ink. Optionally the GPU may also be used to drive one or more loudspeakers 420 of the smart phone.

Alternatively, the speaker may be connected to the CPU via the I/O bridge and the bus. Other components of the smart phone may be similarly connected via the bus, including a touch surface 432 such as a capacitive touch surface overlaid on the screen for the purposes of providing a touch input to the device, a microphone 434 for receiving speech from the user, one or more cameras 436 for capturing images, a global positioning system (GPS) unit 438 for obtaining an estimate of the smart phones geographical position, and wireless communication means 440.

The wireless communication means 440 may in turn comprise several separate wireless communication systems adhering to different standards and/or protocols, such as Bluetooth® (standard or low-energy variants), near field communication and Wi-Fi® as described previously, and also phone based communication such as 2G, 3G and/or 4G.

The systems are typically powered by a battery (not shown) that may be chargeable via a power input (not shown) that in turn may be part of a data link such as USB (not shown).

It will be appreciated that different smartphones may include different features (for example a compass or a buzzer) and may omit some of those listed above (for example a touch surface).

Thus more generally, in an embodiment of the present disclosure a suitable remote device such as smart phone 400 will comprise a CPU and a memory for storing and running an app, and wireless communication means operable to instigate and maintain wireless communication with the e-cigarette 10. It will be appreciated however that the remote device may be a device that has these capabilities, such as a tablet, laptop, smart TV or the like.

Referring again to FIGS. 1 and 4, a vaping monitor system may now be considered.

Such a vaping monitor system may provide a means for a user to monitor and gauge their vaping levels in a way that meaningfully relates to their previous smoking levels, as described herein below.

In more detail, a vaping monitor system may comprise an electronic vapor provision system (EVPS) 10 on its own, or operating in conjunction with a remote device such as a smart phone 400. As discussed previously, the EVPS is operable to generate vapor/aerosol from a payload.

Further, the EVPS is operable to supply inhalation data to a dosage processor. The dosage processor may be the processor 50 of the EVPS, or the processor 410 of the remote device, or the role of the dosage processor may for example be shared between these two physical processors.

The inhalation data is indicative of the amount of payload effectively inhaled by the user, typically on a per-inhalation (puff) basis but optionally on a cumulative basis over a predetermined time period, such as per minute, per hour, per day, or per week, or per a predetermined number of puffs, such as every 5, 10, or any suitable multiple of 5 or 10 up to for example 100.

The inhalation data supplied to the dosage processor may comprise simple sensor measurements, with the final indication of the amount of payload vaporized and inhaled by the user being subsequently calculated by the dosage processor, or the inhalation data may be supplied to the dosage processor in a pre-calculated form, with the calculation for example being performed by the processor of the EVPS.

Based on sensor measurements, the inhalation data representing an amount of payload effectively inhaled by the user may be estimated using any suitable techniques, including any one of the following four techniques.

The amount of payload effectively inhaled by the user may be estimated to a first approximation from the airflow passing through the heater/cartomizer. The amount of vapor generated can be assumed to be proportional to the volume of air that is passed through the EVPS during the puff. The proportionality may be linear or non-linear, and may be determined empirically. The user may then be assumed to inhale all of the generated vapor, or a predetermined proportion. Again the predetermined proportion may be determined empirically.

Hence the vaping monitor system may comprise an airflow sensor operable to supply airflow sensor data to the dosage processor, and the dosage processor is operable to calculate an inhalation amount responsive to the airflow sensor data.

The amount of payload effectively inhaled by the user may be estimated to a second approximation based upon the volume of air that is passed through the EPVS during the puff and also the temperature profile of the heater, or equivalently the activation rate of a non-heat based atomizer, if used. The amount of vapor generated can be assumed to be proportional to temperature of the heater at or above a vaporization temperature for the payload, and hence can be used to modify the estimate of the first approximation. The proportionality may be linear or non-linear, and may be determined empirically.

Hence the dosage processor may be operable to calculate an inhalation profile responsive to temperature sensor data.

The amount of payload vaporized and inhaled by the user may be estimated to a third approximation based upon the volume of air that is passed through the EVPS during the puff, the temperature profile of the heater, and an airflow rate profile for the volume of air. The airflow rate has a strong positive correlation with the depth of inhalation and hence the amount of payload that reaches deep into the lungs, where it may be absorbed into the bloodstream. Hence a fast airflow is indicative of a larger proportion of payload reaching the lungs, whilst a slower airflow is indicative of a smaller proportion of payload reaching the lungs. Hence the amount of vapor effectively inhaled can be assumed to be proportional to the airflow rate, and can be used to modify the estimate of the first or second approximations. The proportionality may be linear or non-linear, and may be determined empirically.

Hence the dosage processor may be operable to calculate an inhalation profile responsive to the airflow sensor data. Typically an integral of this profile will equal the overall amount referred to in the first approximation.

The amount of payload vaporized and inhaled by the user may be estimated to a fourth approximation, as a refinement of the third approximation, based upon an interplay between heater temperature and airflow rate. When the heater temperature is above but close to the vaporization temperature of the payload, intense reduce very fine vapor/aerosol particles which are more easily transported to the lungs, but as the temperature increases, the vaporization rate tends to increase and with it also a tendency to produce larger vapor/aerosol particles which are less easily transported to the lungs. Consequently the temperature profile and airflow rate profile can be evaluated together to determine for example whether a high airflow is coincident with fine particle production, indicative of a large uptake of vapor in the deep lungs, or for example whether lower airflow is consistent with large particle reduction, indicative of small uptake of vapor in the deep lungs. Hence the temperature profile and airflow rate profile can be used to weight the estimated effect of inhalation of the vapor produced, with the amount of vapor produced itself being estimated from the overall volume of air that is passed through the EVPS during the puff, and can be used to modify the estimate of the first, second, or third approximations. The weighting may be linear or non-linear, and may be determined empirically.

Hence the dosage processor may be operable to calculate an inhalation profile responsive to both the temperature sensor data and the airflow sensor data.

As noted above, the dosage processor may receive the sensor data (e.g. from pressure sensor 62, temperature sensor 63, and optionally from any other suitable sensor), in order to calculate the estimate itself. However optionally, for example where the dosage processor is in a smart phone paired with an EVPS, the dosage processor/smart phone may receive as inhalation data either a fully or partially calculated estimate of the amount of payload effectively inhaled by the user, as calculated by a processor in the EVPS. For example, pressure data measurements by the EVPS may be converted into airflow rate data or flow volume data by the processor of the EVPS prior to transmission to the smart phone.

The dosage processor is operable to calculate an amount of an active ingredient such as nicotine delivered to the user's bloodstream, based on pharmacokinetic data for the EVPS, and the inhalation data.

Pharmacokinetic data describes the relationship between the amount of vapor that the user has effectively inhaled, and the amount of active ingredient delivered to the user's blood.

In a first instance, this data can be limited to an estimate of the proportion of active ingredient in the vapor that is absorbed for a given puff, for which the inhalation data described above has been obtained.

Optionally in addition, the pharmacokinetic data can include an estimate for the active ingredient of its metabolism rate to a non-active state within the body or equivalently its rate to excretion. In this case, then optionally in conjunction with a record of the time at which inhalations take place, an estimate of the total active ingredient in the user due to existing active ingredient still being metabolized within the body, and the additional active ingredient estimated to be absorbed with the current puff, can be made.

The pharmacokinetic data can be derived empirically by delivering a known quantity of vapor to at least one and preferably a statistically significant sample of test users, and subsequently measuring the change in level of the active ingredient within their blood.

The dosage processor can then calculate the amount of active ingredient added to the user's bloodstream as equal to the amount indicated by the pharmacokinetic data, multiplied by the ratio of the effective amount of vapor inhaled by the user in the current puff according to the inhalation data compared to the amount of vapor in the delivered known quantity used during empirical testing. Hence if the effective amount of vapor inhaled was identical to the test case, then the dosage processor would calculate that the amount of active ingredient added to the user's blood supply as identical to the amount indicated in the pharmacokinetic data. Meanwhile if the calculated effective amount of vapor inhaled was half that in the test case, the dosage processor may calculate that the amount of active ingredient added to these as the supply is equal to half the amount indicated in the pharmacokinetic data.

The above calculation may be suitable for example for single use e-cigarettes or other e-cigarettes where the replacement payload is of a fixed type and consequently no other variables need to be considered.

However, this estimate can optionally be refined if further data is available; for example, separate pharmacokinetic data may be derived for different vapor particle sizes, and/or different inhalation profiles (for example, a short and fast deep breath, short and slow shallow breath, and/or a long and slow deep breath), if such variables produce a relevant difference in the amount of active ingredient absorbed into the bloodstream. Any suitable combination of these or other variables relevant to the absorption of the active ingredient may be tested for to obtain different sets of pharmacokinetic data.

Consequently, where vapor particle sizes and/or an inhalation profile have been estimated for the current puff, optionally to refine the estimate of the effective amount of vapor currently inhaled, then if available a corresponding set of pharmacokinetic data may be selected, or the closest two sets of pharmacokinetic data may be interpolated, for example as a function of the relative difference between the estimated vapor particle size and inhalation profile and the values in the two sets of pharmacokinetic data.

Furthermore, it will be appreciated that for some EVPS systems, a user may purchase a replacement payload that may have a different concentration of active ingredient to the previous payload or to a default payload, such as that supplied by the manufacturer with the EVPS.

Consequently, the dosage processor may scale the amount of active ingredient estimated to be added to the user's blood supply according to the relative concentration of the active ingredient in the current payload with respect to the concentration of active ingredient in the payload used during testing.

The relative concentration of active ingredient in the payload may be input to the vaping monitor system by any suitable means; for example a dial or slider on the EVPS may be marked with common concentrations and set by the user; for example the dial or slider could control the variable resistor, whose value is then measured and used to indicate the intended concentration.

Alternatively or in addition, the concentration could be input or selected via a user interface on the remote device 400.

Alternatively or in addition, the concentration could be read from a QR code or other machine-readable marker on the packaging of the replacement payload. In this case, the concentration could be included within the data of the marker according to a predetermined data convention, or alternatively the marker could identify the payload, and the corresponding concentration could be retrieved from a look-up table held by the local to the smart phone or other connected device, or held at a central server which can thus be easily updated with new products. Such a server is described later herein.

In any event, the payload for vaporization is thus registered with the dosage processor prior to installation/use of the payload within the EVPS, and the dosage processor uses pharmacokinetic data for the EVPS responsive to the identity of the registered payload. It will be appreciated that this pharmacokinetic data may be the same pharmacokinetic data, but scaled according to the relative concentration compared to that used during empirical testing, as explained previously herein.

Finally optionally, for an EVPS system that can operate at separate district power settings (for example, 10 W, 15 W, or 20 W), separate pharmacokinetic data may be obtained for each setting, or alternatively exhaustive data can be obtained for one setting in conjunction with sufficient testing to determine a scaling factor to convert that data to one or more other settings.

In any event, the dosage processor is thus operable to calculate an amount of an active ingredient delivered to the user's bloodstream based on pharmacokinetic data for the EVPS and the inhalation data.

Separately, pharmacokinetic data can be or has been obtained to show the quantity of active ingredient delivered to the blood from one reference cigarette. For nicotine, an industry-standard reference cigarette exists for which such data can be obtained. It will be appreciated that for other active ingredients, different reference cigarettes may be tested. Hence more generally, pharmacokinetic data can be obtained for any suitable reference conventional combustion product, such as a notional standard cigarette, cigar, pipe or other smoking apparatus for smoking tobacco, or for an alternative botanical such as cannabis. In this latter case, where (like for blood alcohol levels), consumption limits may be legally enforced, and may limit consumption with reference to a blood concentration limit and/or to consumption of a predetermined number of a licensed (and standard) product, then determining an equivalent vaping amount based on pharmacokinetic equivalence may be of particular benefit. It will be also be appreciated that in this case the estimated amount of active ingredient added to the user's blood stream, and optionally the cumulative amount, may also be usefully presented to the user. Similarly, an estimate of the concentration in the user's blood may be made, for example with reference to one or more parametric descriptors of the user, such as weight and optionally height to determine likely blood volume based on a human body model.

In any event, the dosage processor is then operable to convert the calculated amount of an active ingredient into an equivalent number of reference conventional combustion products (e.g. cigarettes) based on pharmacokinetic data for the reference conventional combustion product.

Hence the dosage processor can determine what proportion of conventional combustion products the current puff represents in terms of the amount of active ingredient absorbed by the bloodstream; this provides a meaningful comparison for the user, as it relates to the comparative effects of the EVPS and a standard combustion product such as a cigarette on the user's physiology. As such it is more accurate and more relevant to the subjective experience of the user than, for example, a proxy measure of consumption such as number of puffs, battery drain, or estimate of payload used (for example based on a record of the number of puffs between payload replacements).

The vaping monitor system is then operable to indicate the equivalent number of reference conventional combustion products (e.g. cigarettes) via a user interface.

Typically, this takes the form of a graphical or text display on the smart phone or similar device paired with the EVPS as part of the vaping monitor system. Hence for example an individual puff may be reported as corresponding to 5% of a conventional cigarette, and/or a graphic representation of a cigarette may be shown being consumed by corresponding amount.

Alternatively or in addition, a graphical or text display may be provided on the EVPS itself to similar effect. Alternatively, where such a display is not available on the EVPS, then optionally a light, or other status signifier such as a buzzer may be used to indicate when the equivalent of a threshold proportion of a conventional cigarette is consumed.

Whilst the user may find it helpful see text or graphic report indicating the equivalent amount of cigarette consumed per puff, it will be appreciated that users may want to estimate this equivalence over a longer timescale.

Hence optionally the dosage processor may be adapted to maintain a cumulative count of equivalent combustion products for one or more of the following periods; the current day, the current week, the current month, the current year, and for the duration of the currently installed payload.

The user can then for example see if they are smoking the equivalent of N standard cigarettes per day, where N is a personal target or simply the amount they used to smoke.

Optionally, the pharmacokinetic data for a standard combustion product such as a standard cigarette can also indicate the absorption of other ingredients into the bloodstream; in this case, optionally the user interface for the vaping monitor system can indicate the equivalent amount of other ingredients than the design active ingredient that have not been absorbed into the user's bloodstream.

Similarly optionally, if the cost of payload is input to the vaping monitor system, or alternatively if the payload is part of a pre-packaged EVPS, or if the cost is effectively negligible for the purposes of the calculation, then for a current recommended retail price, the cost of the equivalent number of standard cigarettes and the effective savings to the user gained by using the EVPS could also be displayed.

Optionally, in addition to the standard combustion product, pharmacokinetic data may be similarly obtained for one or more branded combustion products (e.g. branded tobacco products such as particular brands of cigarette or other smoking products). The amount of active ingredient absorbed by a consuming the or each branded combustion product can be identified as a multiple of the amount absorbed by consuming the standard combustion product.

The user may then select a branded combustion product (for example, the particular brand they used prior to using the EVPS) for the purposes of comparison, and the equivalent number of standard combustion products can be scaled by the relevant multiple to provide equivalent number of the branded combustion product. This may be more intuitive to the user and assist with their understanding of the levels of consumption.

Optionally, alternatively for example upon initial use of the system, these may be prompted to select a branded combustion product to use as the standard cigarette, in which case pharmacokinetic data for that branded combustion product may be used in place of the standard cigarette, in which case the conversion would be a multiple of 1, or may be skipped entirely.

As noted previously herein, the EVPS may comprise the dosage processor, or implement some steps of the dosage processor. Similarly, as noted previously herein, the EVPS may comprise a display for displaying the user interface.

However, to provide a potentially richer and more intuitive user interface, the EVPS may be paired with a smart phone or similar device, as described previously herein, running an app that provides the user interface on the display of the phone, and also provides some or all of the dosage processor functionality via the phone's own processor.

Hence a mobile communication device 400 may comprise a receiver 440 (for example a Bluetooth® receiver as described previously herein) operable to receive inhalation data from an electronic vapor provision system (EVPS) 10 operable to generate vapor from a payload in response to an inhalation by user; a dosage processor 410 such as smart phone CPU operable to calculate an amount of an active ingredient delivered to the user's bloodstream based on pharmacokinetic data for the EVPS and the inhalation data; and the dosage processor being operable to convert the calculated amount of an active ingredient into an equivalent number of reference conventional cigarettes based on pharmacokinetic data for the reference conventional cigarette, and a display 418 operable to indicate the equivalent number of reference conventional cigarettes via a user interface.

As noted previously, in a case where the user can select their own payload, then the mobile communication device may comprise an input user interface operable to obtain data identifying the type of payload used with the EVPS and the dosage processor may be operable to calculate the amount of active ingredient delivered to the user's bloodstream responsive to a concentration of active ingredient associated with the identified type of payload.

For example, in this case the input may be a virtual keyboard or drop-down menu to input or select a concentration level, or may be a camera of the smart phone used to extract data from a QR code or similar machine-readable marker on the payload container or its packaging. Similarly the concentration of active ingredient may be found a look up table associated with the identified payload, where the look up table is located either on the smart phone, or on a remote server.

Notably, an app associated with a mobile communication device may in principle be able to operate with multiple types of EVPS. Accordingly, optionally the mobile communication device may comprise an input operable to obtain data identifying the type of EVPS being used and the dosage processor may be operable to calculate the amount of active ingredient delivered to the user's bloodstream responsive to modification data associated with the identified type of EVPS, for example in another look up table, where the look up table is located either on the smart phone, or on a remote server.

Again, the input may be a virtual keyboard or drop-down menu to input or select a type of EVPS, or may be a camera of the smart phone used to extract data from a QR code or similar machine-readable marker on the EVPS or its packaging.

Example modification data may for example relate to the respective cross-sectional area of a central air flow within the particular EVPS; it will be appreciated that for an equivalent change in dynamic pressure, the flow rate and total flow will vary in response to the cross-sectional area of the EVPS. Similarly, modification data may relate to the particular response profile of a pressure sensor or temperature sensor, so that sensor data from such a sensor may be correctly interpreted, if this precursor step was not performed by the EVPS itself. Similarly, modification data may relate to a parameter characterizing the output of the heater; for example different heaters may generate difference amounts of vapor for the same temperature, depending upon their size and/or the nature of their interaction with the payload. It will be appreciated that any suitable accommodation of modification data may be associated with an EVPS.

Subsequently, the calculations described previously herein may be modified accordingly, for example scaling the inhalation amount or inhalation profile according to an air flow correction parameter, modifying a temperature profile, vapor density and/or particle size prediction responsive to a heater correction parameter, and/or modifying any sensor data according to a corresponding sensor correction parameter.

As noted previously herein, accordingly the mobile communication device and the EVPS can operate together as a vaping monitor system.

As noted previously herein, some or all data relating to branded tobacco product specific modification data, payload specific modification data and/or EVPS specific modification data may be held at a server, and provided in response to an enquiry from the mobile communication device or potentially from an EVPS for (example if independently Wi-Fi capable, or using the mobile communication device as a data access point).

Accordingly, a server adapted to provide data to a vaping monitor system may comprise

a receiver adapted to receive a request from the vaping monitor system for modification data, the request comprising identification data for one or more selected from the list consisting of a payload to be installed within an electronic vapor provision system (EVPS) of the vaping monitor system, a branded tobacco product to be used when indicating an equivalent number of conventional cigarettes via the user interface, and an EVPS; a memory comprising a respective look up table associating the identification data with corresponding modification data; a processor operable to obtain the modification data corresponding to the received identification data from the look up table; and a transmitter adapted to transmit the obtained modification data to the vaping monitor system.

As noted above, the modification data for the payload may represent the concentration level of active ingredient within the payload, either as an absolute value or relative to the empirical tests, and/or any other suitable data. Meanwhile the modification data for the branded tobacco product may represent a multiplier for the total amount of active ingredient absorbed into the virtual user compared to a standard cigarette, and/or any other suitable data. Finally the modification data for the EVPS may represent an absolute cross-sectional area or a scaling value for the cross sectional area of the EVPS relative to a default area, and/or correction parameter is relating to properties of the heater and/or sensors of the EVPS.

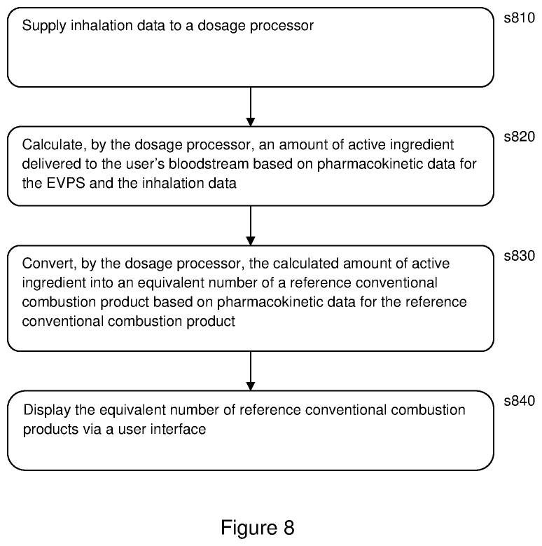

Turning now to FIG. 8, a corresponding vapor monitoring method comprises:
in a first step s810, supplying inhalation data to a dosage processor;
in a second step s820, calculating, by the dosage processor, an amount of active ingredient delivered to the user's bloodstream based on pharmacokinetic data for the EVPS and the inhalation data;
in a third step s830, converting, by the dosage processor, the calculated amount of active ingredient into an equivalent number of a reference conventional combustion product based on pharmacokinetic data for the reference conventional combustion product; and
in a fourth step s840, displaying the equivalent number of reference conventional combustion products via a user interface.

It will be apparent to a person skilled in the art that variations in the above method corresponding to operation of the various embodiments of the apparatus as described and claimed herein are considered within the scope of the present invention, including but not limited to:
supplying airflow data to the dosage processor, and calculating, at the dosage processor, an inhalation profile from the airflow sensor data, and calculate the amount of active ingredient delivered to the user's bloodstream responsive to the inhalation profile;
the dosage processor being in the EVPS;
the dosage processor being in a remote device such as a mobile communication device, and the displaying step comprises displaying the user interface on a display of the remote device;
looking up in a look-up table, for one or more branded combustion products, the amount of active ingredient delivered to the user relative to the reference conventional combustion product, and converting the equivalent number of reference conventional combustion products into an equivalent number of one or more of the branded combustion products, based on the indicated data of the look-up table;
maintaining a cumulative count of equivalent combustion products for one or more selected from the list consisting of the current day, the current week, the current month, the current year, and the currently installed payload; and
registering a payload vaporization with the dosage processor prior to installation of the payload within the EVPS, and the calculating step comprises using pharmacokinetic data for the EVPS responsive to the identity of the registered payload.

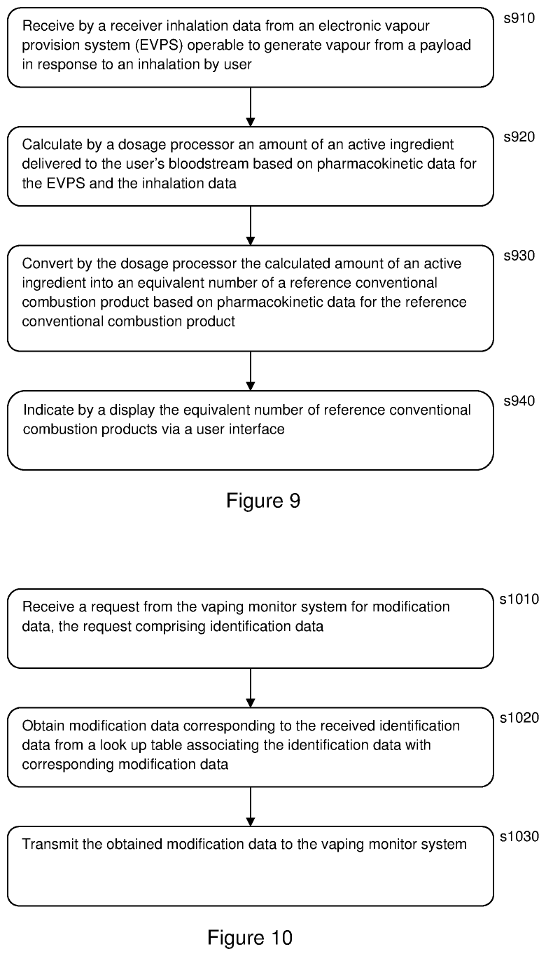

Similarly, referring now to FIG. 9, a vaping monitoring method for a mobile communication device comprises:
in a first step s910, receiving by a receiver inhalation data from an electronic vapor provision system (EVPS) operable to generate vapor from a payload in response to an inhalation by user;
in a second step s920, calculating by a dosage processor an amount of an active ingredient delivered to the user's bloodstream based on pharmacokinetic data for the EVPS and the inhalation data;
in a third step s930, converting by the dosage processor the calculated amount of an active ingredient into an equivalent number of a reference conventional combustion product based on pharmacokinetic data for the reference conventional combustion product; and
in a fourth step s940, indicating by a display the equivalent number of reference conventional combustion products via a user interface.

Again it will be apparent to a person skilled in the art that variations in the above method corresponding to operation of the various embodiments of the apparatus as described and claimed herein are considered within the scope of the present invention, including but not limited to:
obtaining via an input user interface data identifying the type of payload used with the EVPS, and calculating at the dosage processor the amount of active ingredient delivered to the user's bloodstream responsive to a concentration of active ingredient associated with the identified type of payload;
obtaining via an input data identifying the type of EVPS being used, and calculating at the dosage processor the amount of active ingredient delivered to the user's bloodstream responsive to modification data associated with the identified type of EVPS; and
obtaining the identifying data from a remote server.

Finally, referring now to FIG. 10, a vaping monitoring method for a server comprises:
in a first step s1010, receiving a request from the vaping monitor system for modification data, the request comprising identification data for one or more selected from the list consisting of:
   i. a payload to be installed within an electronic vapor provision system (EVPS) of the vaping monitor system;
   ii. a branded combustion product to be used when indicating an equivalent number of conventional combustion products via the user interface; and
   iii. an EVPS,
in a second step s1020, obtaining modification data corresponding to the received identification data from a look up table associating the identification data with corresponding modification data; and
in a third step s1030, transmitting the obtained modification data to the vaping monitor system.

It will be appreciated that the above methods may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

1. A vaping monitor system, comprising:
an electronic vapor provision system (EVPS) operable to generate vapor from a payload in response to an inhalation by a user, and to supply inhalation data to a dosage processor indicative of the amount of payload effectively inhaled by the user during inhalation;
a dosage processor operable to calculate an amount of an active ingredient delivered to the user's bloodstream based on pharmacokinetic data for the EVPS and the inhalation data; and
the dosage processor being operable to convert the calculated amount of an active ingredient into an equivalent number of a reference conventional combustion product based on pharmacokinetic data for the reference conventional combustion product, and
the vaping monitor system being operable to indicate the equivalent number of a reference conventional combustion product via a user interface.

2. The vaping monitor system of claim 1, comprising:
an airflow sensor operable to supply airflow sensor data to the dosage processor;
wherein the dosage processor is configured to calculate an inhalation profile responsive to the airflow sensor data and calculate the amount of active ingredient delivered to the user's bloodstream responsive to the inhalation profile.

3. The vaping monitor system of claim 1, comprising:
a temperature sensor operable to supply temperature sensor data to the dosage processor;
wherein the dosage processor is operable to calculate an inhalation profile responsive to the temperature sensor data and calculate the amount of active ingredient delivered to the user's bloodstream responsive to the inhalation profile.

4. The vaping monitor system of claim 1, wherein the EVPS comprises the dosage processor.

5. The vaping monitor system of claim 4, wherein the EVPS comprises a display for displaying the user interface.

6. The vaping monitor system of claim 1, further comprising a remote device, wherein the remote device comprises the dosage processor.

7. The vaping monitor system of claim 6, wherein the remote device comprises a display for displaying the user interface.

8. The vaping monitor system of claim 1, wherein the vaping monitor system comprises a look-up table indicating, for one or more branded combustion products, the amount of active ingredient delivered to the user relative to the reference conventional combustion product; and wherein the dosage processor is operable to convert the equivalent number of reference conventional combustion products into an equivalent number of one or more of the branded combustion products, based on the indicated data of the look-up table.

9. The vaping monitor system of claim 1, wherein the dosage processor maintains a cumulative count of equivalent combustion products for one or more selected from the list consisting of:
i. the current day;
ii. the current week;
iii. the current month;
iv. the current year; and
v. the currently installed payload.

10. The vaping monitor system of claim 1, in which:
a payload for vaporization is registered with the dosage processor prior to installation of the payload within the EVPS; and
the dosage processor uses pharmacokinetic data for the EVPS responsive to the identity of the registered payload.

11. A mobile communication device comprising:
a receiver operable to receive inhalation data, indicative of the amount of payload effectively inhaled by the user during inhalation, from an electronic vapor provision system (EVPS) operable to generate vapor from a payload in response to an inhalation by user;
a dosage processor operable to calculate an amount of an active ingredient delivered to the user's bloodstream based on pharmacokinetic data for the EVPS and the inhalation data;
the dosage processor being operable to convert the calculated amount of an active ingredient into an equivalent number of a reference conventional combustion product based on pharmacokinetic data for the reference conventional combustion product; and
a display operable to indicate the equivalent number of reference conventional combustion products via a user interface.

12. A mobile communication device according to claim 11, comprising
an input user interface operable to obtain data identifying the type of payload used with the EVPS;
wherein the dosage processor is operable to calculate the amount of active ingredient delivered to the user's bloodstream responsive to a concentration of active ingredient associated with the identified type of payload.

13. A mobile communication device according to claim 11, comprising:
an input operable to obtain data identifying the type of EVPS being used; and
wherein the dosage processor is operable to calculate the amount of active ingredient delivered to the user's bloodstream responsive to modification data associated with the identified type of EVPS.

14. A mobile communication device according to claim 12, in which the identifying data is obtained from a remote server.

15. (canceled)

16. A vapor monitoring method comprising the steps of:
supplying inhalation data to a dosage processor that is indicative of the amount of payload effectively inhaled by the user during inhalation;
calculating, by the dosage processor, an amount of active ingredient delivered to the user's bloodstream based on pharmacokinetic data for the EVPS and the inhalation data;
converting, by the dosage processor, the calculated amount of active ingredient into an equivalent number of a reference conventional combustion product based on pharmacokinetic data for the reference conventional combustion product; and
displaying the equivalent number of reference conventional combustion products via a user interface.

17. The vapor monitoring method of claim 16, comprising:
supplying airflow data to the dosage processor that is indicative of the amount of payload effectively inhaled by the user during inhalation; and
calculating, at the dosage processor, an inhalation profile from the airflow sensor data, and calculate the amount of active ingredient delivered to the user's bloodstream responsive to the inhalation profile.

18. The vapor monitoring method of claim 16, in which the dosage processor is in the EVPS.

19. The vapor monitoring method of claim 16, in which the dosage processor is in a remote device, and the displaying comprises displaying the user interface on a display of the remote device.

20. The vaping monitoring method of claim 16, further comprising:
looking up in a look-up table, for one or more branded combustion products, the amount of active ingredient delivered to the user relative to the reference conventional combustion product; and
converting the equivalent number of reference conventional combustion products into an equivalent number of one or more of the branded combustion products, based on the indicated data of the look-up table.

21. The vaping monitoring method of claim 16, further comprising:
maintaining a cumulative count of equivalent combustion products for one or more selected from the list consisting of:
i. the current day;
ii. the current week;
iii. the current month;
iv. the current year; and
v. the currently installed payload.

22. The vaping monitoring method of claim 16, further comprising:
registering a payload vaporization with the dosage processor prior to installation of the payload within the EVPS; and
the calculating comprises using pharmacokinetic data for the EVPS responsive to the identity of the registered payload.

23. A vaping monitoring method for a mobile communication device, comprising:
receiving by a receiver inhalation data, indicative of the amount of payload effectively inhaled by the user during inhalation, from an electronic vapor provision system (EVPS) operable to generate vapor from a payload in response to an inhalation by user;
calculating by a dosage processor an amount of an active ingredient delivered to the user's bloodstream based on pharmacokinetic data for the EVPS and the inhalation data;
converting by the dosage processor the calculated amount of an active ingredient into an equivalent number of a reference conventional combustion product based on pharmacokinetic data for the reference conventional combustion product; and
indicating by a display the equivalent number of reference conventional combustion products via a user interface.

24. (canceled)

25. (canceled)
